(19) United States
(12) Patent Application Publication
(10) Pub. No.: US 2023/0028809 A1
(43) Pub. Date: Jan. 26, 2023

(54) PROCEDURE, METHOD, SYSTEM AND BUSINESS MODEL OF DIRECT ADVERTISING ON PERSONAL ELECTRONIC AND OTHER DEVICES

(71) Applicant: Aleksandar Colic, Belgrade (RS)

(72) Inventor: Aleksandar Colic, Belgrade (RS)

(21) Appl. No.: 17/789,198

(22) PCT Filed: Nov. 25, 2020
(86) PCT No.: PCT/RS2020/000019

§ 371 Date: Jun. 26, 2022

(30) Foreign Application Priority Data
Nov. 26, 2019 (RS) P-2019/1514

(51) Int. Cl. G06Q 30/02

(52) U.S. Cl. CPC G06Q 30/0258; G06Q 30/0272

(57) ABSTRACT

The present invention business model, process, method and system of direct advertising in the personal electronic and other devices is a procedure that overcomes so far insurmountable obstacle advertising on personal devices, which do not depend either on the internet providers, TV channels, radio channels, Internet companies, but the direct interests of consumers (users) that they receive particular device free of charge or fora symbolic fee, and the vendor (seller) who has interest because of profit and covering costs from the sate of advertising space on above mentioned device, in a way both parties have an interest to cooperate and you get the procedure that exceeds the shortcomings in advertising on personal devices.

### TECHNICAL FIELD

The invention belongs to the field of Physics, i.e. the procedure, method, system and business model of advertising on electronic and other devices (television, mobile phones, tablets, computers, smart lenses, smart glasses, etc.) According to the international classification, the patent designation is G06Q20/02.

### BACKCGROUND ART

Such a business model, procedure, method and system of direct advertising on personal electronic and other devices does not currently exist in the offer of any company, either domestic or foreign. The development of such a procedure is a novelty in the world, in propaganda materials, literature, such a business model, procedure, method and system of direct advertising on personal electronic and other devices does not exist.

### DISCLOSURE OF INVENTION

The present invention business model, process, method and system of direct advertising in the personal electronic and other devices is a procedure that overcomes so far insurmountable obstacle advertising on personal devices, which do not depend either on the internet providers, TV channels, radio channels, Internet companies, but the direct interests of consumers (users) that they receive particular device free of charge or for a symbolic fee, and the vendor (seller) who has interest because of profit and covering costs from the sale of advertising space on above mentioned device, in a way both parties have an interest to cooperate and you get the procedure that exceeds the shortcomings in advertising on personal devices.

### BRIEF DESCRIPTION OF DRAWINGS

FIG. 1 display a process of business model, procedure and method how advertising on personal devices works, and FIG. 2 display a process.

### INDUSTRIAL APPLICABILITY

Industrial applicability solved by the present invention is a business model, procedure, method and system of direct advertising on personal electronic and other devices which provides possibility of large and mass direct advertising, overcoming the problem of personal approval and legal restrictions, such a model, procedure, method and system solves the technical problem in question.

### DESCRIPTION

The business model, procedure, method and system of direct advertising on personal electronic and other devices is based on the relationship between consumers and vendors (advertisers), which is currently limited worldwide by the Laws on Advertising, Privacy, and the possibility of direct sending an advertising message. The procedure refers to the end user having so give consent for the use of his device for broadcasting advertising messages in the same way, the way to obtain that consent is by donating the device, or with a symbolic fee with a contractual obligation that the vendor (advertiser) has the right to send advertising messages, thus creating a mutual connection between the consumer and the vendor (advertiser) to the mutual satisfaction.

The invention also relates to a method and possibilities of advertising on personal electronic and other devices and collecting data from them. The advantage of the invention is that the problem of obtaining the necessary consent of the consumer for the purpose of placing advertising messages is overcome, because the consumer himself has an interest in the entire procedure.

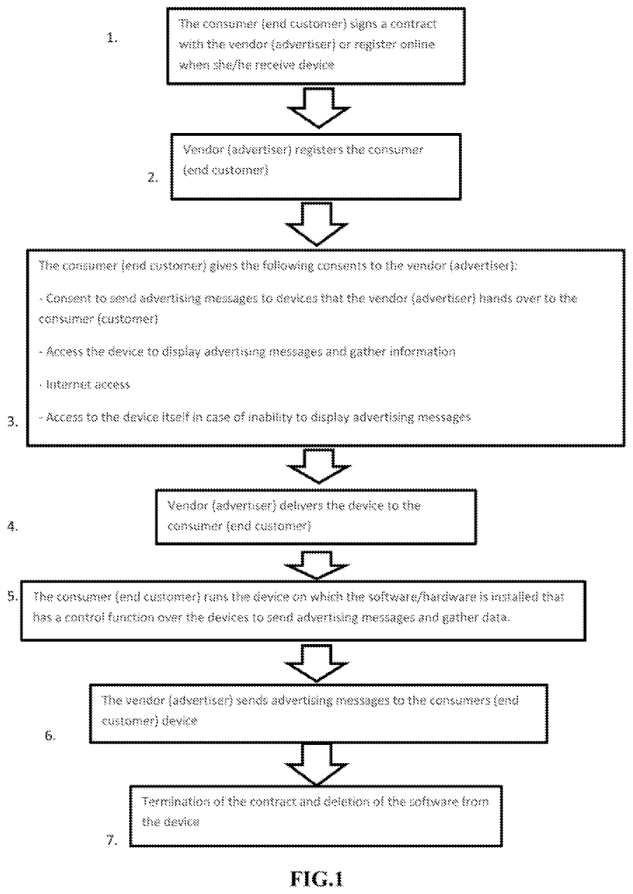

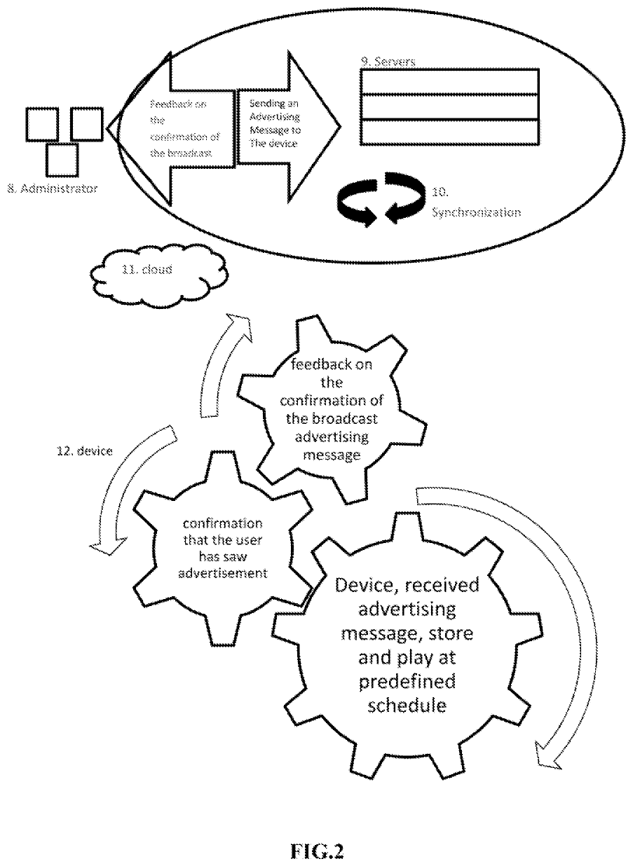

1. The business model, process, method and system of direct advertising on personal electronic and other devices indicated in FIG. 1 defines the relationship between the user and the advertiser supporting the business model, process, method and system of invention where to ensure consent, and broadcast advertising, message on personal devices, that before or during the use of a particular device the user accepts to receive advertising messages on the personal device FIG. 1, a contract is signed between the consumer (end customer) and vendor (advertiser) 1, vendor (advertiser) registers the consumer (end customer) 2, the consumer (end customer) gives the following consents to the vendor (advertiser) to send advertising messages to the personal device, access the device to display advertising messages and collect information related to searches, interests of the user, etc. and access to the device in case of impossibility to display advertising messages 3, the device in question which the consumer (user) wants and which is defined by the contract is given for free of charge or with a symbolic fee to the user 4. With the aforementioned condition. The user can accept terms and conditions through the very form of the terms of use of the device when he/she receive desired device or with a previously signed contract, which is limited to a certain period of time, where during that time the user may not touch the software and hardware in order to prevent the display of advertising messages. After that the consumer starts the device 5. After activation, the vendor (advertiser) has the right to sends advertising messages to the user (consumer) 6. After the expiration of the agreed period, the device itself deletes the advertising codes during the next software synchronization and the user can use the device at its discretion and has no further obligations to the vendor (advertiser) 7.

2. Business model, procedure, method and system of direct advertising on personal electronic and other devices indicated in FIG. 2. Defines the advertising procedure where the administrator 8. Sends an advertising message or a block of advertising messages to the device via server 9. Or cloud 11. To device 12. Which has the function to deliver and implement a block of advertising messages for a certain period of time and send a report that the user received it and saw it back via cloud 11. Or server 9. To the administrator 8. Where the device 12. Is synchronized 10. With the administrator 8. As vendor see fit to send advertising content.

3. Business model, procedure, method and system of direct advertising on personal electronic and other devices can be adapted to future technologies, where such advertising process can be integrated into the same or combined with other technologies using the same procedure, method, system and the business model of advertising.
